(19) United States
(12) Patent Application Publication
(10) Pub. No.: US 2025/0078815 A1
(43) Pub. Date: Mar. 6, 2025

(54) QUANTIZATION AND SPARSITY AWARE FINE-TUNING FOR SPEECH RECOGNITION WITH UNIVERSAL SPEECH MODELS

(71) Applicant: Google LLC, Mountain View, CA (US)

(72) Inventors: Shaojin Ding, Mountain View, CA (US); David Qiu, Fremont, CA (US); David Rim, Mountain View, CA (US); Amir Yazdanbakhsh, Mountain View, CA (US); Yanzhang He, Mountain View, CA (US); Zhonglin Han, Mountain View, CA (US); Rohit Prakash Prabhavalkar, Santa Clara, CA (US); Weiran Wang, Iowa City, IA (US); Bo Li, Fremont, CA (US); Jian Li, Mountain View, CA (US); Tara N. Sainath, Jersey City, NJ (US); Shivani Agrawal, Mountain View, CA (US); Oleg Rybakov, Mountain View, CA (US)

(73) Assignee: Google LLC, Mountain View, CA (US)

(21) Appl. No.: 18/826,135

(22) Filed: Sep. 5, 2024

Related U.S. Application Data
(60) Provisional application No. 63/580,969, filed on Sep. 6, 2023.

(51) Int. Cl. G10L 15/06

(52) U.S. Cl. CPC G10L 15/063; G10L 2015/0635

(57) ABSTRACT

A method includes obtaining a plurality of training samples that each include a respective speech utterance and a respective textual utterance representing a transcription of the respective speech utterance. The method also includes fine-tuning, using quantization and sparsity aware training with native integer operations, a pre-trained automatic speech recognition (ASR) model on the plurality of training samples. Here, the pre-trained ASR model includes a plurality of weights and the fine-tuning includes pruning one or more weights of the plurality of weights using a sparsity mask and quantizing each weight of the plurality of weights based on an integer with a fixed-bit width. The method also includes providing the fine-tuned ASR model to a user device.

### CROSS-REFERENCE TO RELATED APPLICATIONS

This U.S. patent application claims priority under 35 U.S.C. § 119(e) to U.S. Provisional Application 63/580,969, filed on Sep. 6, 2023. The disclosure of this prior application is considered part of the disclosure of this application and is hereby incorporated by reference in its entirety.

### TECHNICAL FIELD

This disclosure relates to quantization and sparsity aware fine-tuning for speech recognition with universal speech models.

### BACKGROUND

End-to-end automatic speech recognition (ASR) models have seen revolutionary quality gains with the recent development of large-scale universal speech models (USM). However, the massive size of these models (e.g., several billions of parameters) makes the models expensive to deploy due to the need of considerable amounts of memory and computational units. Therefore, efficient fine-tuning and model compression algorithms have become unprecedentedly important research topics.

### SUMMARY

One aspect of the disclosure provides a computer-implemented method that when executed on data processing hardware causes the data processing hardware to perform operations that include obtaining a plurality of training samples, wherein each respective training sample of the plurality of training samples includes a respective speech utterance and a respective textual utterance representing a transcription of the respective speech utterance. The operations also include fine-tuning, using quantization and sparsity aware training with native integer operations, a pre-trained automatic speech recognition (ASR) model on the plurality of training samples. The pre-trained ASR model includes a plurality of weights and fine-tuning the pre-trained ASR model includes pruning one or more weights of the plurality of weights using a sparsity mask and quantizing each weight of the plurality of weights based on an integer with a fixed-bit width. The operations also include providing the fine-tuned ASR model to a user device.

Implementations of the disclosure may include one or more of the following optional features. In some implementations, pruning the one or more weights includes generating a binary mask and applying the binary mask to the plurality of weights. In these implementations, the binary mask may be based on an N:M sparsity pattern, wherein A/represents a consecutive number of weights of the plurality of weights and N represents a maximum number of non-zero values. The sparsity mask may include a binary mask.

In some examples, the fixed-bit width is four. Here, quantizing each weight of the plurality of weights may include applying symmetric quantization. In other examples, the fixed-bit width is two. Here, quantizing each weight of the plurality of weights may include applying asymmetric quantization and sub-channel quantization. The ASR model may include one or more multi-head attention layers. Here, the one or more multi-head attention layers may include one or more transformer layers or one or more conformer layers.

Another aspect of the disclosure provides a system that includes data processing hardware and memory hardware storing instructions that when executed on the data processing hardware causes the data processing hardware to perform operations that include obtaining a plurality of training samples, wherein each respective training sample of the plurality of training samples includes a respective speech utterance and a respective textual utterance representing a transcription of the respective speech utterance. The operations also include fine-tuning, using quantization and sparsity aware training with native integer operations, a pre-trained automatic speech recognition (ASR) model on the plurality of training samples. The pre-trained ASR model includes a plurality of weights and fine-tuning the pre-trained ASR model includes pruning one or more weights of the plurality of weights using a sparsity mask and quantizing each weight of the plurality of weights based on an integer with a fixed-bit width. The operations also include providing the fine-tuned ASR model to a user device.

This aspect of the disclosure may include one or more of the following optional features. In some implementations, pruning the one or more weights includes generating a binary mask and applying the binary mask to the plurality of weights. In these implementations, the binary mask may be based on an N:M sparsity pattern, wherein A represents a consecutive number of weights of the plurality of weights and N represents a maximum number of non-zero values. The sparsity mask may include a binary mask.

In some examples, the fixed-bit width is four. Here, quantizing each weight of the plurality of weights may include applying symmetric quantization. In other examples, the fixed-bit width is two. Here, quantizing each weight of the plurality of weights may include applying asymmetric quantization and sub-channel quantization. The ASR model may include one or more multi-head attention layers. Here, the one or more multi-head attention layers may include one or more transformer layers or one or more conformer layers.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for performing speech recognition.

FIG. 2 is a schematic view of a Recurrent Neural Network-Transducer (RNN-T) model architecture.

FIGS. 3A-3C are schematic views of an example training process for pre-training an audio encoder of a speech recognition model.

FIG. 4 is a schematic view of an example training process for fine-tuning a pre-trained audio encoder using quantization and sparsity aware training.

FIG. 5 is a schematic view of example steps performed by the sparsity aware training of the training process of FIG. 4.

FIG. 6 is an example algorithm of the training process of FIG. 4.

FIG. 7 is a flowchart of an example arrangement of operations for a method of jointly using quantization aware training and sparsity aware training while fine-tuning a pre-trained speech recognition model.

FIG. 8 is a schematic view of an example computing device that may be used to implement the systems and methods described herein.

Like reference symbols in the various drawings indicate like elements.

### DETAILED DESCRIPTION

End-to-end automatic speech recognition (ASR) models have seen revolutionary quality gains with the recent development of large-scale universal speech models (USM). However, the massive size of these models (e.g., several billions of parameters) makes the models expensive to deploy due to the need of considerable amounts of memory and computational units. Therefore, efficient fine-tuning and model compression algorithms have become unprecedentedly important research topics.

More recently, with the rapid emergence of large-scale datasets and high capacity data processing hardware, such as graphics processing units (GPUs) and tensor processing units (TPUs), self-supervised learned (SSL) ASR models see a trend of growing larger in size by scaling convention SSL ASR models up in order to capture multi-domain and multi-lingual distributions. As such, these SSL ASR models can serve as universal foundational models for most of speech processing tasks. However, as these SSL ASR models are expensive to deploy due to their massive size, efficient fine-tuning and model compression algorithms have become unprecedentedly important topics of research.

Quantization is a technique to reduce the computational and memory costs of ASR models by representing the weights and/or activations with lower precision data types (e.g., and 8-bit integer) instead of a conventional 32-bit floating point value. Among modern model quantization methods, post training quantization (PTQ) with 8-bit integers (int8) is a popular and easy to use technique that has been successfully applied in many applications. However, one of the drawbacks of such a technique is the potential performance degradation due to the loss of precision. Another limitation of PTQ is the lack of control over model quantization. For example, PTQ may not support 4-bit integer (int4) quantization or customized quantization of selected set of layers. Sparsity is another technique for reducing the computational and memory costs of ASR models. When using sparsity, nodes are pruned based on entropy of weights and node activity.

Implementations herein include a model trainer that trains/fine-tunes a pre-trained ASR model using native quantization aware and sparsity aware training with native integer operations. That is, while fine-turning the pre-trained ASR model on a supervised training data set, the model trainer uses native quantization aware training and sparsity aware training with native integer operations to compress the size of the resulting ASR model. Quantization reduces model complexity from parameter precision, while sparsity focuses on matrix topology. More specifically, the combination of quantization aware and sparsity aware training is implemented for fine-tuning of the pre-trained ASR model by using low-bit quantization and a N:M structured sparsity aware paradigm on model weights, where both techniques are hardware friendly and are supported by modern GPUs and TPUs The ASR model may be pre-trained using self-supervised learning techniques. In contrast to some methods that use “fake” quantization aware training (i.e., using float operations and later using a conversion to convert the floats to integers), native quantization aware training uses native integer operations to execute quantized operations (e.g. matrix multiplications) which generates models that do not have any difference in accuracy during training and inference. That is, “fake quantization” can have a numerical difference between training (i.e., with float operations) and inference (i.e., with integer operations) modes when the float operation do not fit into the bits of mantissa during training. Moreover, the combination of sparsity and quantization for compression provides significant speed up during both training and inference while exhibiting only minor word error rate (WER) regression. For instance, implementations herein using the combination of 2:4 sparsity and 4-bit quantization for compression achieve significant speed up during both training and inference while only having a 12.1-percent (12.1%) WER regression when the ASR model is compressed to 9.4-percent (9.4%) of its original float32 size. This is a significant technological improvement compared to models that perform compression post training of the ASR model which experience a significant drop in WER regression.

Implementations are directed toward compressing the ASR model during a fine-tuning stage of the ASR model as opposed to performing compression during the initial pre-training stage of the ASR model or after the ASR model has been trained and fine-tuned. Notably, the dense and compressed versions of the ASR model usually have very different distributions at convergence. In some examples, when initializing from the near-optimal pre-trained weights of the dense version of the ASR model, the distribution of the dense version of the ASR model is adapted to be optimal for the compressed version of the ASR model within limited training steps. This process of adapting the distribution for optimizing the compressed version of the ASR model can be a challenging task.

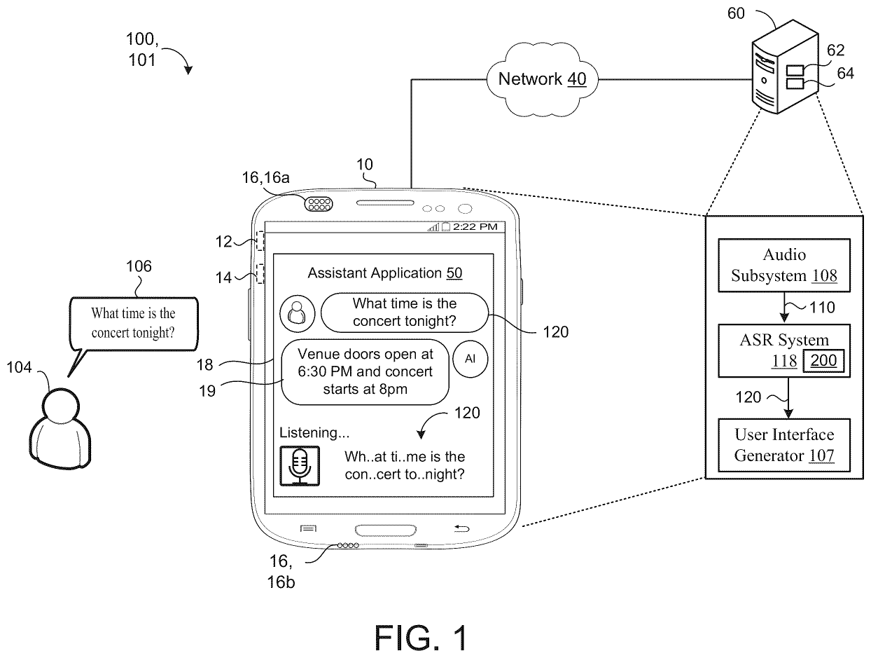

FIG. 1 is an example of a system 100 operating in a speech environment 101. In the speech environment 101, a user's 104 manner of interacting with a computing device, such as a user device 10, may be through voice input. The user device 10 (also referred to generally as a device 10) is configured to capture sounds (e.g., streaming audio data) from one or more users 104 within the speech environment 100. Here, the streaming audio data may refer to a spoken utterance 106 by the user 104 that functions as an audible query, a command for the device 10, or an audible communication captured by the device 10. Speech-enabled systems of the device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and storing instructions, that when executed by the data processing hardware 12, causes the data processing hardware 12 to perform one or more operations. The user device 10 further includes an audio system 16 with an audio capture device (e.g., microphone) 16, 16a for capturing and converting spoken utterances 106 within the speech environment 100 into electrical signals and a speech output device (e.g., a speaker) 16, 16b for communicating an audible audio signal (e.g., as output audio data from the device 10). While the user device 10 implements a single audio capture device 16a in the example shown, the user device 10 may implement an array of audio capture devices 16a without departing from the scope of the present disclosure, whereby one or more capture devices 16a in the array may not physically reside on the user device 10, but be in communication with the audio system 16.

In the speech environment 100, an automated speech recognition (ASR) system 118 includes an ASR model 200 (such as an ASR model having a recurrent neural network-transducer (RNN-T model architecture or other transducer model/multi-pass model) that resides on the user device 10 of the user 104 and/or on a remote computing device 60 (e.g., one or more remote servers of a distributed system executing in a cloud-computing environment) in communication with the user device 10 via a network 40. The remote computing device 60 is equipped with data processing hardware 62 and memory hardware 64. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into corresponding audio data (e.g., acoustic frames) 110 for input to the ASR system 118. Thereafter, the model 200 receives, as input, the audio frames 110 (i.e., audio data) corresponding to the utterance 106, and generates/predicts, as output, a corresponding transcription 120 (e.g., speech recognition result/hypothesis) of the utterance 106.

The user device 10 and/or the remote computing device 60 also executes a user interface generator 107 configured to present a representation of the transcription 120 of the utterance 106 to the user 104 of the user device 10. As described in greater detail below, the user interface generator 107 may display the speech recognition results 120 in a streaming fashion. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by the audio systems 16 of the user device 10. In this example, the audio subsystem 108 receives the spoken utterance 106 and converts it into acoustic frames 110 for input to the ASR system 118.

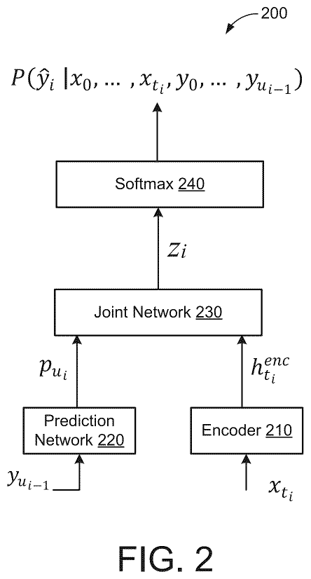

Referring to FIG. 2, an example frame alignment-based transducer model 200 includes a Recurrent Neural Network-Transducer (RNN-T) model architecture which adheres to latency constrains associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210, a prediction network 220, and a Joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1)) x=(x₁, x₂, . . . , x_{T}), where xₜ∈R_{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋ₜ into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of self-attention layers/blocks, such as conformer layers/blocks. In some examples, the relative attention in each self-attention layer is equal to 16 attention heads. Here, each conformer block includes a series of multi-headed self attention, depth wise convolution and feed-forward layers. The stack of self-attention layers/blocks may include transformer layers/blocks in other examples. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

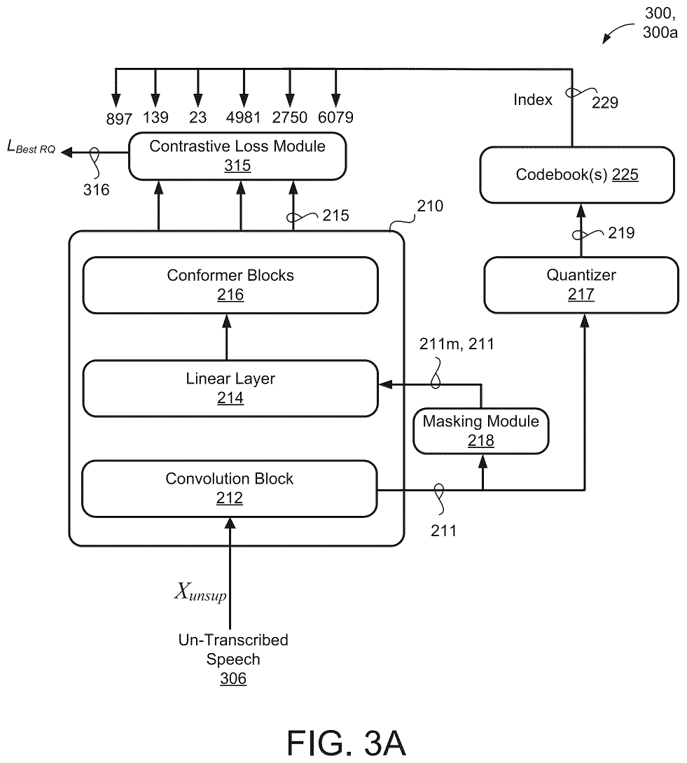

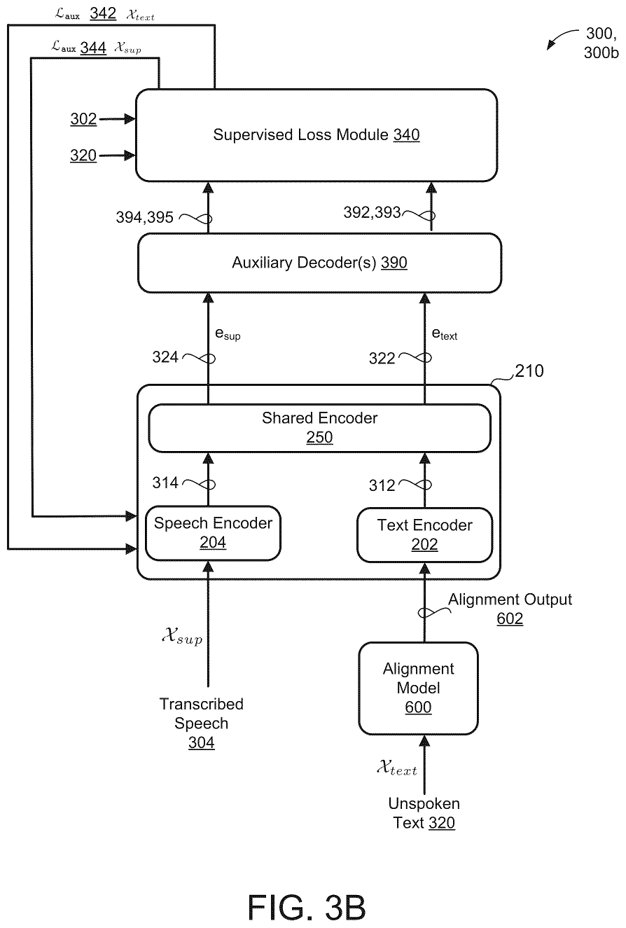

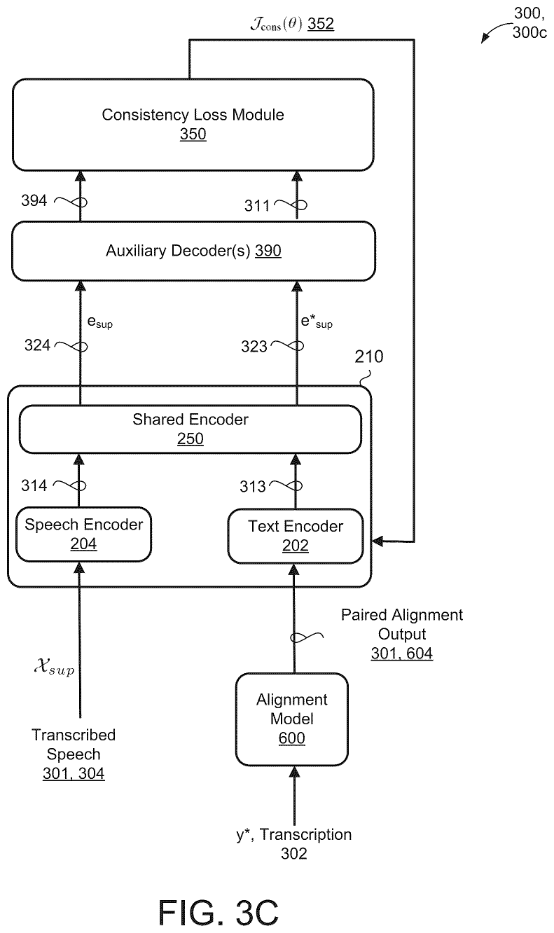

FIGS. 3A-3C illustrate an example training process 300 for pre-training the audio encoder 210 of the ASR model 200 (FIG. 2). The training process 300 may pre-train the audio encoder 210 using available training data that includes a set of unspoken textual utterances (Xₜₑₓₜ) 320, a set of transcribed non-synthetic speech utterances (Xₛᵤₚ) 304, and/or un-transcribed non-synthetic speech utterances (Xᵤₙₛᵤₚ) 306. Each unspoken textual utterance 320 includes text-only data (i.e., unpaired data) such that each unspoken textual utterance 320 is not paired with any corresponding spoken audio representation (i.e., speech) of the utterance. The unspoken textual utterance 320 may include any sequence text chunks including words, word-pieces, phonemes, and/or graphemes. Each un-transcribed non-synthetic speech utterance 306 (also referred to as simply “un-transcribed speech utterance 306”) includes audio-only data (i.e., unpaired data) such that the un-transcribed speech utterance 306 is not paired with any corresponding transcription. On the other hand, each transcribed non-synthetic speech utterance 304 (also referred to as simply “transcribed speech utterance 304”) includes a corresponding transcription 302 paired with a corresponding non-synthetic speech representation of the corresponding transcribed speech utterance 304.

For simplicity, the training process 300 includes a contrastive self-supervised loss part 300a (FIG. 3A), a supervised loss part 300b (FIG. 3D), and a consistency regularization part 300c (FIG. 3). The self-supervised loss part 300a may interchangeably referred to as Best-RQ training. The training process 300 pre-trains the audio encoder 210 on a total loss (Lₜₜₛ₄ₚᵣₑₜᵣₐᵢₙ) based on: contrastive losses (L_{Best RQ}) 316 derived using the contrastive self-supervised loss part 300a from the un-transcribed non-synthetic speech utterances (Xᵤₙₛᵤₚ) 306; supervised losses (Lₐᵤₓ) 342, 344 derived using the supervised loss part 300b from the unspoken training text utterances (Xₜₑₓₜ) 320 and the transcribed non-synthetic speech utterances (Xₛᵤₚ) 304; and consistency losses ( [symbol] _{cons}(θ)) 352 derived using the consistency regularization part 300c.

Referring to FIG. 3A, in some implementations, the audio encoder 210 includes a speech encoder 204 and a text encoder 202, described in more detail with reference to FIGS. 3B and 3C. In the example shown, the audio encoder 210 (alternatively the speech encoder 204 or the text encoder 202 (FIGS. 3D and 3C)) includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed non-synthetic speech utterance 304 and each un-transcribed non-synthetic speech utterance 306, and generates, as output, for each of a plurality of output steps, an encoded audio feature 211 that corresponds to a respective one of the transcribed non-synthetic speech utterances 304 or a respective one of the un-transcribed non-synthetic speech utterances 306. The convolution subsampling block 212 may receive, as input, each alignment output 602 and generate, as output, for each of the plurality of output steps, an encoded textual feature 213 that corresponds to a respective one of the alignment outputs 602.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. Thereafter, a contrastive loss module 315 derives a contrastive loss (L_{w2v}) 316 between the contrastive context vectors 215 at the masked positions and the target context vectors 219 as follows.

$${ℒ}_{w 2 v} = - log \frac{exp ( sim ( {c}_{t} , {q}_{t} ) / k )}{{\sum }_{\tilde{q} - {Q}_{t}} exp ( sim ( {c}_{t} , \tilde{q} ) / k )} \qquad ( 1 )$$

where cₜ is contrastive context vector 215 centered over a masked time step t and qₜ represents a target context vector 219 at the time step t in a set of K+1 candidate target context vectors 219 which includes qₜ and K distractors. Distractors may be uniformly sampled from other masked time steps of the same utterance.

The contrastive loss 316 is optimized between the contrastive context vectors 215 at the masked positions and the target context vectors 219. After the audio encoder 210 converges on the un-transcribed non-synthetic speech utterances 306, the pre-training procedure is repeated on both the alignment outputs 602 corresponding to the unspoken textual utterance 320 and the transcribed non-synthetic speech utterances 304. Thus, the contrastive loss (L_{w2v}) is optimized for both real/human (non-synthetic) and unspoken textual utterances 320 represented by alignment outputs 602, with additional auxiliary losses on the transcribed non-synthetic speech utterances 304 and the alignment outputs 602 as described in greater detail below with reference to FIG. 3B. Accordingly, the training process 300a pre-trains the audio encoder 210 on the derived contrastive loss 316 applied on the corresponding encoded features 211, 213 associated with each alignment output 602, each transcribed non-synthetic speech utterance 304, and each un-transcribed non-synthetic speech utterance 306 provided as input to the audio encoder 210. Pre-training the audio encoder 210 may include updating parameters of the audio encoder 210 based on the contrastive losses 316.

Referring to FIG. 3D, the supervised loss part 300b of the training process 300 is configured to inject lexical information into the audio encoder 210 during pre-training based on supervised loss terms 342, 344 derived from the transcribed non-synthetic speech utterances 304 and alignment outputs 602 corresponding to unspoken textual utterances 320 output by the alignment model 600. The alignment model 600 is configured to generate, at each of a plurality of output steps, the alignment outputs (i.e., textual representation) 602 for each of a plurality of unspoken training text utterances 320. The unspoken textual utterances 320 (also referred to as simply “unspoken textual utterance 320”) includes unspoken text that is text-only data, i.e., unpaired data, such that each unspoken textual utterance (Xₜₑₓₜ) 320 is not paired with any synthesized or non-synthesized speech. Accordingly, the alignment model 600 generates a corresponding alignment output 602 for each of the unspoken textual utterances 320.

Notably, the supervised loss part 300b leverages one or more auxiliary decoders 390 for generating the supervised loss terms 342, 344. The auxiliary decoders 390 may include Connectionist Temporal Classification (CTC) decoders, Listen Attend Spell (LAS) decoders, or RNN-T decoders. These auxiliary decoders 390 may include at least one of a phoneme decoder configured to decode a sequence of phonemes or a wordpiece decoder configured to decode a sequence of word pieces. The auxiliary decoders 390 could also include a grapheme decoder configured to decode a sequence of graphemes.

During the supervised loss part 300b, the text encoder 202 of the audio encoder 210 is configured to receive alignment outputs 602 (i.e., text embeddings) from the alignment model 600 and the speech encoder 204 is configured to receive transcribed non-synthetic speech utterances 304. That is, the text encoder 202 of the audio encoder 210 generates encoded textual representations 312 for alignment outputs 602 (e.g., corresponding to an unspoken textual utterance 320) and the speech encoder 204 of the audio encoder 210 generates encoded audio representations 314 for speech inputs (i.e., transcribed non-synthetic speech utterances 304). Here, the encoded textual representations 312 and the encoded audio representations 314 may not both be compatible with the auxiliary decoders 390. Thus, the audio encoder 210 may also include a shared encoder 250 that receives the encoded textual representations 312 as input, and generates a first encoded shared representation 322 (eₜₑₓₜ) as output. Moreover, the shared encoder 250 receives the encoded audio representations 314 as input, and generates a second encoded shared representation (eₛᵤₚ) 324 as output. Accordingly, the shared encoder 250 generates the first and second encoded shared representations 322, 324 into a shared latent representation space compatible with the auxiliary decoder 390.

In particular, the shared encoder 250 receives, as input, each encoded textual representation 312 that corresponds to the alignment output 602 generated from the unspoken textual utterance 320 and generates, as output, for each of a plurality of time steps, the first encoded shared representation (eₜₑₓₜ) 322 that corresponds to the alignment output 602 at the corresponding time step. The auxiliary decoder 390 including the phoneme decoder or the wordpiece decoder receives, as input, each first encoded shared representation 322 output from the shared encoder 250 and generates, as output, a first probability distribution 392 over possible speech recognition hypotheses for the corresponding alignment output 602 at the corresponding time step. In some examples, the first probability distribution 392 over possible speech recognition hypotheses includes one of possible phoneme labels, possible word piece labels, or possible grapheme labels. Thereafter, a supervised loss module 340 may determine an alignment output loss term 342 based on the first probability distribution 392 over possible speech recognition hypotheses for the alignment output 602 corresponding to the unspoken textual utterance 320. Here, the corresponding unspoken textual utterance 320 in which the alignment output 602 is generated from also serves as a ground-truth transcription 302. The supervised loss part 300b may pre-train the audio encoder 210 on the alignment output loss term 342 by updating parameters of the audio encoder 210 using the alignment output loss term 342.

Similarly, during the supervised loss part 300b, the shared encoder 250 receives, as input, each transcribed encoded audio representation 314 that corresponds to the non-synthetic speech utterance 304 and generates, as output, for each of a plurality of time steps, a second encoded shared representation (eₛᵤₚ) 324 that corresponds to the transcribed non-synthetic speech utterance 304 at the corresponding time step. The auxiliary decoder 390 including the phoneme decoder or the wordpiece decoder receives, as input, each second encoded shared representation 324 output from the shared encoder 250 and generates, as output, a second probability distribution 394 over possible non-synthetic speech recognition hypotheses for the corresponding transcribed non-synthetic speech utterance 304 at the corresponding time step. In some examples, the second probability distribution 394 over possible non-synthetic speech recognition hypotheses includes the one of possible phoneme labels, the possible word piece labels, or the possible grapheme labels. Thereafter, the supervised loss module 340 may determine a non-synthetic speech loss term 344 based on the second probability distribution 394 over possible non-synthetic speech recognition hypotheses and the corresponding transcription 302 paired with the transcribed non-synthetic speech utterance 304. Here, the corresponding transcription 302 serves as a ground-truth transcription and may include a sequence of target phonemes, target word pieces, and/or target graphemes. The supervised loss part 300b may pre-train the audio encoder 210 on the non-synthetic speech loss term 344 by updating parameters of the audio encoder 210 using the non-synthetic speech loss term 344.

In some implementations, the supervised loss part 300b of the training process 300 uses another auxiliary decoder 390 to generate a third probability distribution 393 over possible speech recognition hypotheses based on the first encoded shared representation (eₜₑₓₜ) 322 for the alignment output 602 at the corresponding time step, whereby the supervised loss module 340 may determine another alignment output loss term 342 based on the third probability distribution 393 and the unspoken textual utterance 320 corresponding to the alignment output 602. Here, the other auxiliary decoder 390 includes the other one of the phoneme decoder, word piece decoder, or the grapheme decoder and the third probability distribution 393 over possible speech recognition hypotheses includes the other one of the possible phoneme labels, the possible word piece labels, or the possible grapheme labels. In these implementations, the other auxiliary decoder 290 also generates a fourth probability distribution 395 over possible non-synthetic speech recognition hypotheses for the corresponding second encoded shared representation 324 at the corresponding time step, whereby the supervised loss module 340 may determine another non-synthetic speech loss term 344 based on the fourth probability distribution 395 and the corresponding transcription 302 that is paired with the transcribed non-synthetic speech representation 304. Here, the fourth probability distribution 395 over possible non-synthetic speech recognition hypotheses includes the other one of the possible phoneme labels, the possible word piece labels, or the possible grapheme labels. The supervised loss part 300b of the training process 300 may similarly pre-train the audio encoder 210 on the other alignment output loss term 342 and the other non-synthetic speech loss term 344.

The un-transcribed non-synthetic speech utterances 306 and the unspoken textual utterances 320 each correspond to “unpaired” training data whereby the contrastive loss (L_{w2v}) 316 derived from the unspoken textual utterances (Xₜₑₓₜ) 320 may be combined with the supervised loss [symbol] ₐᵤₓ associated with the alignment output loss term 342 to obtain an unspoken textual loss function, [symbol] ₜₑₓₜ, as follows.

$${𝒥}_{text} = {ℒ}_{w 2 v} ( x \vert {θ}_{e} ) + {ℒ}_{aux} ( y \vert x , {θ}_{e} , {θ}_{d} ) \qquad ( 2 )$$

Likewise, the contrastive loss (L_{Best RQ}) 316 derived from the tin-transcribed non-synthetic speech utterances (Xᵤₙₛᵤₚ) 306 may be used to express an unsupervised speech loss function, [symbol] _{unsup_speech}, as follows.

$${𝒥}_{unsup\_speech} = {𝒥}_{Best RQ} ( {x}^{*} \vert {θ}_{e} ) \qquad ( 3 )$$

During pre-training of the audio encoder 210, the alignment outputs 602 and the un-transcribed non-synthetic utterances 306 may be separated or mixed within each batch. In order to force the audio encoder 210 to learn representations that are effective for both alignment outputs 602 corresponding to unspoken textual utterances 320 and non-synthetic (human/real) speech, the loss mask σ is applied when combining the loss functions [symbol] ₜₑₓₜ and of Equations. 5 and 6 to obtain an unpaired data loss function, [symbol] _{unpaired}, as follows.

$${𝒥}_{unpaired} = σ {𝒥}_{text} + ( 1 - σ ) {𝒥}_{speech} \qquad ( 4 )$$

The transcribed non-synthetic speech utterances 304 corresponds to “paired” and “supervised” training data whereby the derived contrastive loss L_{Best RQ} and the derived supervised loss [symbol] ₐᵤₓ associated with the non-synthetic speech loss term 344 may be combined to obtain a paired data loss function, [symbol] _{paired} as follows.

$${𝒥}_{paired} = {ℒ}_{Best RQ} ( x \vert {θ}_{e} ) + {ℒ}_{aux} ( y \vert x , {θ}_{e} , {θ}_{d} ) \qquad ( 5 )$$

Referring to FIG. 3C, the consistency regularization part (i.e., modality matching part) 300c of the training process 300 is configured to promote the audio encoder 210 to learn consistent predictions between non-synthetic speech (e.g. real/human speech) and alignment outputs 602 corresponding to unspoken textual utterances 320 by generating a consistent loss term ( [symbol] _{cons}(θ)) 352 between training utterance pairs 301 that each include a corresponding one of the transcribed non-synthetic speech utterances (Xₛᵤₚ) 304 and a paired alignment output 604 of the same utterance as the corresponding transcribed non-synthetic speech utterance 304. As such, the non-synthetic speech utterance 304 and the paired alignment output 604 of each training utterance pair 301 is associated with a same ground-truth transcription. In short, the consistent loss term 352 between the transcribed non-synthetic speech utterance 304 and paired alignment output 604 of the same training utterance provides an unsupervised training aspect by encouraging the audio encoder 210 to behave consistently regardless of whether the training utterance belongs to non-synthetic speech (i.e., speech training data) or the alignment output (i.e., text training data) and independent of supervised loss terms between the ground-truth transcription 302 and each of: non-synthetic speech recognition hypotheses output by the auxiliary decoder 390; and speech recognition hypothesis output by the auxiliary decoder 390.

Similar to the alignment outputs 602 generated from the unspoken textual utterances 320 in FIG. 3B, the alignment model 600 may generate each paired alignment output 604 using the corresponding transcription 302 that is paired with the transcribed non-synthetic speech utterance 304. Here, the non-synthetic speech representation 304 is associated with paired alignment output 604 generated by the alignment model 600 mapping the unspoken textual utterance 320 into speech frames.

During the consistency regularization part 300c, the text encoder 202 receives, as input, each paired alignment output 604 and generates, as output, for each of a plurality of time steps, an encoded textual representation 313 that corresponds to the paired alignment output 604 at the corresponding time step. The shared encoder 250 receives, as input, the encoded textual representation 313 and generates, as output, a first encoded shared representation (e*ₛᵤₚ) 323. The auxiliary decoder 390 including the phoneme decoder or the wordpiece decoder receives, as input, each first encoded shared representation 323 output from the shared encoder 250 and generates, as output, a first probability distribution 311 over possible speech recognition hypotheses for the corresponding paired alignment output 604 at the corresponding time step. In some examples, the first probability distribution 311 over possible speech recognition hypotheses includes one of possible phoneme labels or possible word piece labels.

Similarly, the speech encoder 204 receives, as input, each transcribed non-synthetic speech utterance 304 as a sequence of features/vectors (e.g., mel-frequency spectrograms such as the acoustic frames 110 of FIG. 1) and generates, as output, for each of a plurality of time steps, a encoded audio representation 314 that corresponds to the transcribed non-synthetic speech utterance 304 at the corresponding time step. The shared encoder 250 receives, as input, the encoded audio representation 314 and generates, as output, a second encoded shared representation (eₛᵤₚ) 324. The auxiliary decoder 390 including the phoneme decoder or the wordpiece decoder receives, as input, each second encoded shared representation 324 output from the shared encoder 250 and generates, as output, a second probability distribution 394 over possible non-synthetic speech recognition hypotheses for the corresponding transcribed non-synthetic speech utterance 304 at the corresponding time step. In some examples, the second probability distribution 394 over possible non-synthetic speech recognition hypotheses includes the one of the possible phoneme labels or the possible word piece labels.

With continued reference to FIG. 3C, the consistency regularization part 300c of the training process 300 further determines, at each of the plurality of time steps for each training utterance pair 301, the consistent loss term ( [symbol] _{cons}(θ)) 352 for the corresponding training utterance pair 301 based on the first probability distribution 311 over possible speech recognition hypotheses and the second probability distribution 394 over possible non-synthetic speech recognition hypotheses. For instance, the training process 300 may employ a consistency loss term module 350 configured to receive, at each time step, the corresponding non-synthetic speech and speech recognition results 311, 394 output by the auxiliary decoder 390, and determine the consistency loss term 352 for the corresponding training utterance pair 301 at the time step.

In some examples, the consistency regularization part 300c of the training process 300 determines the consistent loss term 352 based on a Kullback-Leibler divergence (D) between the first probability distribution 311 over possible speech recognition hypotheses and the second probability distribution 394 over possible non-synthetic speech recognition hypotheses. The consistent loss term 352 based on D_{KL} may be expressed by the following equation.

$${𝒥}_{cons} ( θ ) = {𝒟}_{KL} ( {p}_{\tilde{θ}} ( y \vert x ) ‖ {p}_{θ} ( y \vert \hat{x} ) ) \qquad ( 6 )$$

Here, the consistent loss term 352 determined for the training utterance pair 301 at each time step provides an “unsupervised” loss term that is independent of the accuracy of the auxiliary decoder 390 (e.g., independent of the supervised loss terms 342, 344 of FIG. 3B), and thus, may be employed to update parameters of the audio encoder 210 for promoting consistency between non-synthetic speech representations and alignment outputs of the same utterances. In batch training, the consistent loss term 352 may correspond to an average loss term obtained for the batch. In other words, the consistent loss term 352 permits the audio encoder 210 to learn to behave the same, e.g., make consistent encoded representation predictions on both non-synthetic speech (e.g., real/human speech) and alignment outputs of a same training utterance, regardless of whether the training utterance belongs to non-synthetic speech or alignment outputs.

Lastly, the training process 300 may combine the unpaired data loss function ( [symbol] _{unpaired}), the paired data loss function ( [symbol] _{paired}), and the consistent loss term ( [symbol] _{cons}) to obtain an overall loss term, [symbol] ₜₜₛ₄ₚᵣₑₜₐᵢₙ₂, that may be expressed as follows.

$${𝒥}_{tts 4 pretrain 2} = {𝒥}_{unpaired} + {λ}_{1} 𝒥 paired + {λ}_{2} {𝒥}_{cons} \qquad ( 7 )$$

where λ₁ may be equal to 1.0 and λ₂ is equal to 0.1. The training process 300 may pre-train the audio encoder 210 using the overall loss term, [symbol] ₜₜₛ₄ₚᵣₑₜᵣₐᵢₙ₂, by updating parameters of the audio encoder 210 to effectively teach the audio encoder 210 to learn shared representations between speech and text. Implementations described above describe the training process 300 of FIGS. 3A-3C pre-training the audio encoder 210, however, it is understood that the training process 300 may also be employed to train/pre-train a monolingual ASR model 200 or a multilingual ASR model 200. In some implementations, the training process 300 only employs the contrastive self supervised loss part 300a (e.g., Best RQ training) for pre-training the audio encoder 210 based on the contrastive losses (L_{Best RQ}) 316 derived the un-transcribed non-synthetic speech utterances (Xᵤₙₛᵤₚ) 306. As such, the supervised loss part 300b and the consistency regularization part 300c of the training process 300 may be optional for pre-training the audio encoder 210.

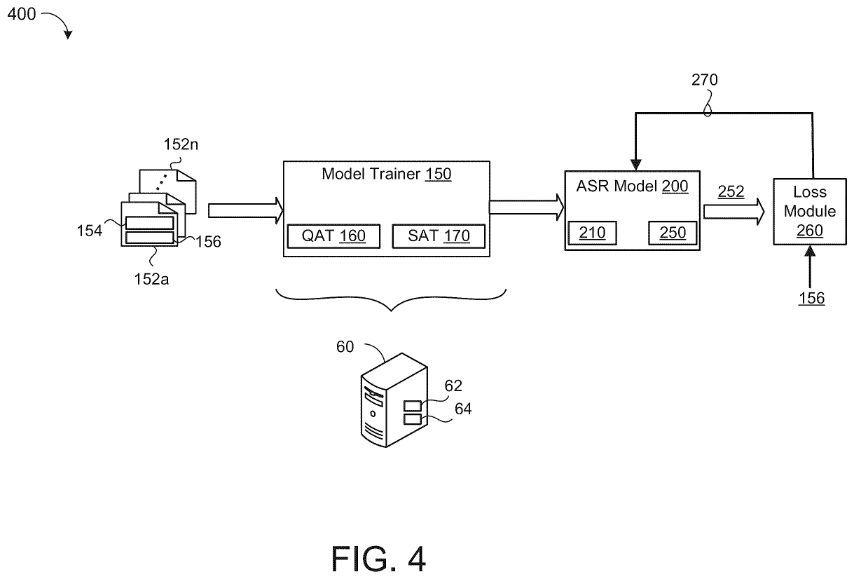

After pre-training the audio encoder 210 using the training process 300, FIG. 4 shows a training process 400 for fine-tuning, using quantization and sparsity aware training with native integer operations, the pre-trained audio encoder 210 on a plurality of supervised training samples 152, 152a-n to teach an ASR model 200 implementing the pre-trained audio encoder 210 to learn how to transcribe spoken utterances. As described in greater detail below, the fine-tuning using the quantization and sparsity aware training with native integer operations may result a fully trained ASR model 200 that is compressed to 9.4% of its original float32 size with only a 12.1% relative WER regression. Here, the massive pre-trained audio encoder 210 is compressed to 9.4% of its original float32 size. The ASR model 200 may implement a randomly initialized softmax layer corresponding to a word-piece model (WPM) 250 for decoding audio encodings output from the audio encoder 210 into a sequence of wordpieces that f a transcription 120 of speech characterized by audio frames 210 input to the ASR model 200. Thus, the ASR model 200 may include a connectionist temporal classification (CTC)-based model architecture having the audio encoder 210 only without any auto-regressive dependency that can be easily parallelized, and therefore more efficient for large-scale models than ASR models implementing RNN-T or Listen, Attend, Spell (LAS) model architectures. The ASR model 200 fine-tuned by the training process 200 may include the RNN-T (FIG. 2) or LAS model architectures that also lead to improved performance due to the additional language modeling capability, however these models run in an auto-regressive manner during inference to thereby lead to much higher latency due to the difficulty to parallelize during inference.

A model trainer 150 running on the remote computing system 60 may execute the training process 400 for fine-tuning the pre-trained ASR model 200 on the plurality of training samples 152 while using quantization and sparsity aware training with native integer operations to compress the size of the resulting ASR model 200. Each training sample 152 includes a spoken training utterance 154 (i.e., a sequence of input audio features) and corresponding textual utterance 156 representing a transcription 156 of the utterance 154. For each spoken training utterance 154, the ASR model 200 predicts corresponding speech recognition results 252 and a loss module 260 generates a corresponding training loss 270 based on the speech recognition results 250 and the corresponding textual utterance 154 associated with a ground-truth transcription. In some examples, when the ASR model 200 includes the CTC model architecture, the training loss 270 includes a CTC loss for fine-tuning the ASR model 200. During the training process 400 to fine-tune the ASR model 200 implementing the pre-trained audio encoder 210, the model trainer 150 applies a combination of native quantization aware training (QAT) 160 and sparsity aware training (SAT) 170 for compressing the size of the ASR model 200.

The pre-trained audio encoder 210 of the ASR model 200 includes a plurality of weights and the training process 400 performs QAT 160 by quantizing each weight of the plurality of weights based on an integer with a fixed-bit weight width. Based on a single linear layer matrix multiplication of Y=X×W, where X^{T}∈R^{J}, Y^{T}∈R^{J}, and W∈R^{I×J} denote the input, output, and weight, respectively, the QAT 160 may run a matrix multiplication with per-channel weight quantization to represent the linear layer matrix multiplication as:

$${Y}_{j} = {s}_{j} \cdot [ X \times Quantize ( {W}_{j} ) ] , 1 \leq j \leq J \qquad ( 8 )$$

$$Quantize ( {W}_{j} ) = ( \frac{{w}_{j}}{{s}_{j}} ) \qquad ( 9 )$$

where sⱼ∈R denotes the scale of the j-th channel and Wⱼ is the j-th column of W. Here, the scale may be computed by dividing a maximum value of Wj with a maximum value of the integer range. For int8 and int4 quantization, the QAT 160 may use a simplest symmetric quantization of [−127, 127] for int8 and [−7, 7] for int4. Here, int8 denotes the integer with a fixed-bit weight width equal to eight (8) while int4 denotes the integer with a fixed-bit weight width equal to (4). However, for reducing precision to 2-bit (i.e., a fixed-bit weight width equal to two (2), symmetric quantization under-utilizes the quantization buckets, i.e., only three values are used. Therefore, the QAT 160 may adopt asymmetric quantization for int2 models, along with sub-channel quantization, which splits a channel into several groups with dedicated scales for each group. Here, int2 denotes the integer with the fixed-bit weight width equal to two (2).

During forward propagation of the QAT 160, the model trainer 150 may apply Equation (8) to all the fully-connected layers of the audio encoder 210 of the ASR model 200, and use a straight-through estimator (STE) to bypass a rounding function that is not derivative at back propagation (e.g., zero derivative almost everywhere). For instance, a quantized weight from Equation (9) may be cast to the native integer type. By contrast to the commonly used “fake” quantization techniques that use float operations during training an integer operations during inference, the QAT 160 applied by the training process 400 avoids any numerical difference caused by operation mismatches between training an inference.

With continued reference to FIG. 4, the training process 400 performs the SAT 170 by pruning one or more weights of the plurality of weights of the audio encoder 210 of the ASR model 200 using a sparsity mask. In some implementations, the sparsity mask includes a binary mask. Here, the binary mask may be based on an N:M sparsity pattern, wherein A represents a consecutive number of weights of the plurality of weights and N represents a maximum number of non-zero integers. Stated differently, for each group of M consecutive weights, there are at most. N non-zero values. Accordingly, pruning the one or more weights of the audio encoder 210 may include generating the binary mask based on the N:M sparsity pattern and applying the binary mask to the plurality of weights. The present disclosure may set the value of M equal to 4 for simplicity, however, the value of M is non-limiting and the present disclosure can be easily extended to patterns with setting arbitrary values for M.

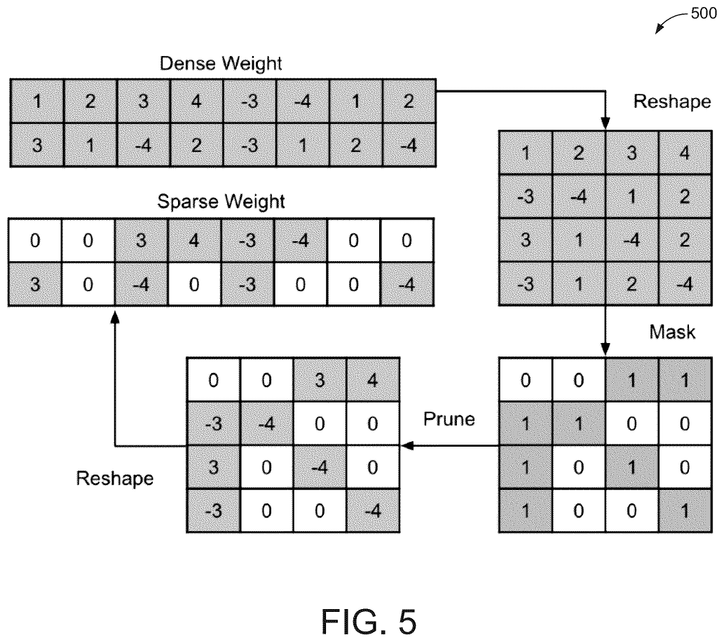

FIG. 5 shows a schematic view 500 of an example pruning step applied by the SAT 170 that first reshapes a dense weight matrix of the ASR model 200 to be equal to V∈R^{K×M} Reshape(W), wherein K denotes a number of groups of M consecutive weights. Thereafter, the SAT 170 identifies the N-th largest magnitude weight, ϕk, for each group, and generates the binary mask M∈{0,1}^{K×m} as follows:

$${M}_{km} = \{ \begin{matrix}1 \vert {W}_{km} \vert \geq ϕ k \\ 0 \vert {W}_{km} \vert < ϕ k\end{matrix} , 1 \leq k \leq , 1 \leq m \leq M \qquad ( 10 )$$

The reshaped weight V may be pruned by the mask as follows:

$$Prune ( V ) = V ⊙ M \qquad ( 11 )$$

where ⊙ denotes the element-wise product. Finally, the SAT 170 reshapes the pruned sparse weight (Prune(V)) back to the original shape.

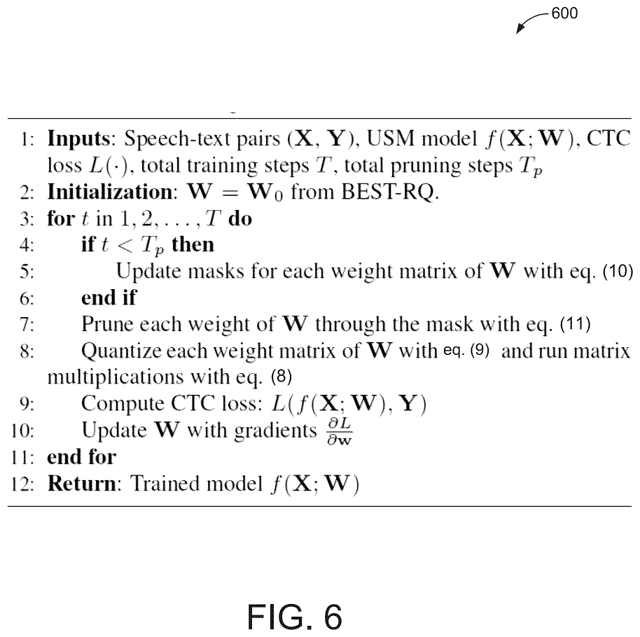

Applying QAT 160 and SAT 170 alone with high compression ratio introduces inevitable WER regression for 2-bit quantization and 1:4 sparsity. In some implementations, the training process 400 compresses the audio encoder 210 of the ASR model 200 from aspects of parameter precision and matrix topology jointly, with a combination of QAT 160 and SAT 170. Specifically, these implementations may utilize a prune-and-quantize approach such that pruned weights are set to zero, thereby permitting direct mapping to the zero-point of symmetric quantization without any effect on calculating the scale. FIG. 6 shows an example algorithm of the training process 400 for fine-tuning the pre-trained ASR model 200 that jointly uses QAT 160 and SAT 170 to compress the size of the ASR model 200.

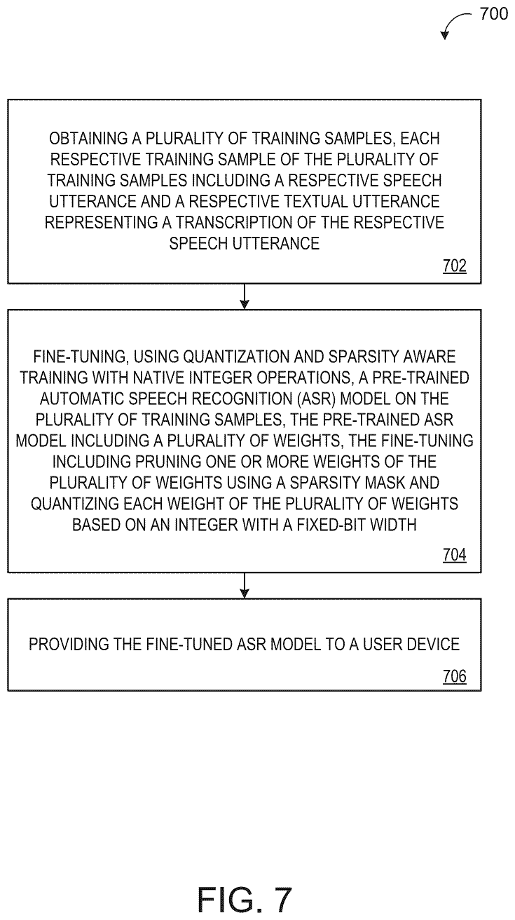

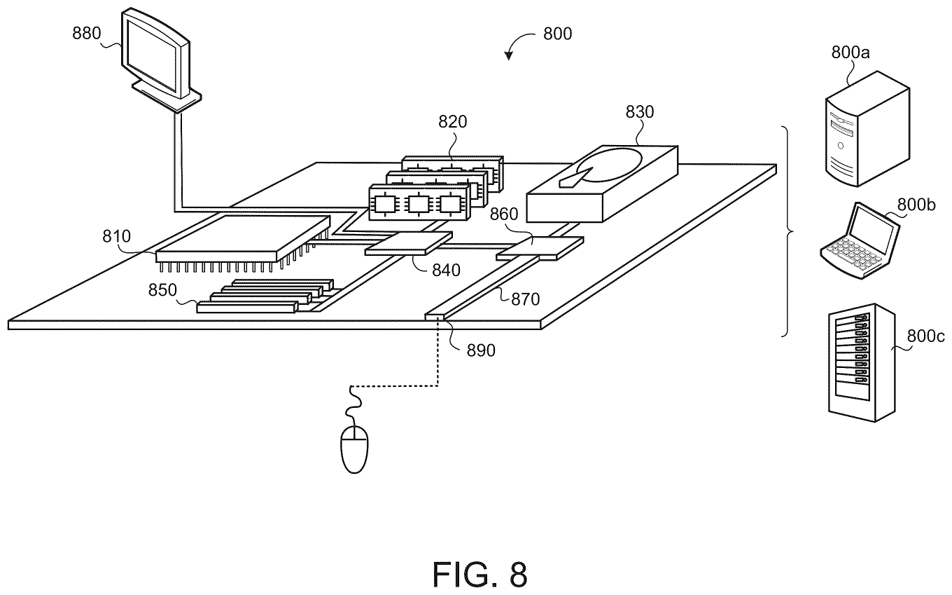

FIG. 7 is a flowchart of an exemplary arrangement of operations for a method 700 of quantization and sparsity aware fine-tuning speech recognition models. The method 700 may execute on data processing hardware 810 (FIG. 8) based on instructions stored on memory hardware 820 (FIG. 8). The data processing hardware 810 may include the data processing hardware 62 of the remote computing system 60 and the memory hardware 820 may include the memory hardware 64 of the remote computing system 60.

At operation 702, the method 700 includes obtaining a plurality of training samples 152. Each respective training sample 152 of the plurality of training samples 152 includes a respective speech utterance 154 paired with a respective textual utterance 156 representing a transcription of the respective speech utterance. Accordingly, the training samples 152 may include supervised training samples 152. At operation 704, the method 700 also includes fine-tuning, using quantization and sparsity aware training with native integer operations, a pre-trained automatic speech recognition (ASR) model 200 on the plurality of training samples. Here, the ASR model 200 may include a CTC ASR model 200 implementing a pre-trained audio encoder having a wordpiece model 250 overlain overtop. The audio encoder 210 may be pre-trained using the training process 300 of FIGS. 3A-3C. In some examples, the audio encoder 210 is pre-trained using only the contrastive self-supervised loss part 300a (FIG. 3A) of the training process 300a. The pre-trained ASR model 200, and more specifically, the pre-trained audio encoder 210 includes a plurality of weights. The fine-tuning includes pruning one or more weights of the plurality of weights using a sparsity mask and quantizing each weight of the plurality of weights based on an integer with a fixed-bit width. At operation 706, the method 700 includes providing the fine-tuned ASR model 200 to a user device 10. The user device may execute the fine-tuned ASR model 200 having a compressed size from the quantization and sparsity aware training used during the fine-tuning stage such that the fine-tuned ASR model 200 may perform speech recognition on the user device 10. Additionally or alternatively, the fine-tuned ASR model 200 may execute on a remote computing device in communication with the user device 10 for performing speech recognition on spoken utterances captured by the user device 10 and communicated to the remote computing device.

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
obtaining a plurality of training samples, each respective training sample of the plurality of training samples comprising:
a respective speech utterance; and
a respective textual utterance representing a transcription of the respective speech utterance;
fine-tuning, using quantization and sparsity aware training with native integer operations, a pre-trained automatic speech recognition (ASR) model on the plurality of training samples, the pre-trained ASR model comprising a plurality of weights, the fine-tuning comprising:
pruning one or more weights of the plurality of weights using a sparsity mask; and
quantizing each weight of the plurality of weights based on an integer with a fixed-bit width; and
providing the fine-tuned ASR model to a user device.

2. The method of claim 1, wherein the sparsity mask comprises a binary mask.

3. The method of claim 1, wherein pruning the one or more weights comprises:
generating a binary mask; and
applying the binary mask to the plurality of weights.

4. The method of claim 3, wherein the binary mask is based on an N:M sparsity pattern, wherein M represents a consecutive number of weights of the plurality of weights and N represents a maximum number of non-zero values.

5. The method of claim 1, wherein the fixed-bit width is four.

6. The method of claim 5, wherein quantizing each weight of the plurality of weights comprises applying symmetric quantization.

7. The method of claim 1, wherein the fixed-bit width is two.

8. The method of claim 7, wherein quantizing each weight of the plurality of weights comprises quantizing each weight of the plurality of weights using asymmetric quantization and sub-channel quantization

9. The method of claim 1, wherein the ASR model comprises one or more multi-head attention layers.

10. The method of claim 9, wherein the one or more multi-head attention layers comprise one or more conformer layers or one or more transformer layers.

11. A system comprising:
data processing hardware; and
memory hardware in communication with the data processing hardware, the memory hardware storing instructions that when executed on the data processing hardware cause the data processing hardware to perform operations comprising:
obtaining a plurality of training samples, each respective training sample of the plurality of training samples comprising:
a respective speech utterance; and
a respective textual utterance representing a transcription of the respective speech utterance;
fine-tuning, using quantization and sparsity aware training with native integer operations, a pre-trained automatic speech recognition (ASR) model on the plurality of training samples, the pre-trained ASR model comprising a plurality of weights, the fine-tuning comprising:
pruning one or more weights of the plurality of weights using a sparsity mask; and
quantizing each weight of the plurality of weights based on an integer with a fixed-bit width; and
providing the fine-tuned ASR model to a user device.

12. The system of claim 11, wherein the sparsity mask comprises a binary mask.

13. The system of claim 11, wherein pruning the one or more weights comprises:
generating a binary mask; and
applying the binary mask to the plurality of weights.

14. The system of claim 13, wherein the binary mask is based on an N:M sparsity pattern, wherein M represents a consecutive number of weights of the plurality of weights and N represents a maximum number of non-zero values.

15. The system of claim 11, wherein the fixed-bit width is four.

16. The system of claim 15, wherein quantizing each weight of the plurality of weights comprises applying symmetric quantization.

17. The system of claim 11, wherein the fixed-bit width is two.

18. The system of claim 17, wherein quantizing each weight of the plurality of weights comprises quantizing each weight of the plurality of weights using asymmetric quantization and sub-channel quantization

19. The system of claim 11, wherein the ASR model comprises one or more multi-head attention layers.

20. The system of claim 19, wherein the one or more multi-head attention layers comprise one or more conformer layers or one or more transformer layers.
